(19) United States
(12) Patent Application Publication
(10) Pub. No.: US 2026/0261511 A1
(43) Pub. Date: Sep. 3, 2026

(54) Multicast Traffic Over Static MPLS Pseudowire Tunnels

(71) Applicant: Arista Networks, Inc., Santa Clara, CA (US)

(72) Inventors: Shriprama RAO, Austin, TX (US); Kaushik Kumar RAM, San Jose, CA (US)

(21) Appl. No.: 19/067,271

(22) Filed: Feb. 28, 2025

(51) Int. Cl. H04L 45/50; H04L 12/46; H04L 45/00

(52) U.S. Cl. CPC H04L 45/50; H04L 12/4633; H04L 12/4641; H04L 45/566

(57) ABSTRACT

The present disclosure describes encapsulating (and decapsulating) Layer 2 multicast traffic from a given interface or subinterface for transmission over a Layer 3 tunnel; e.g., a Generic Routing Encapsulation (GRE) tunnel. A static Multiprotocol Label Switching (MPLS) label is added to identify a virtual private network (VPN) connection, and the GRE tunnel is used to transport the VPN packets to a remote end. During encapsulation for transmitting multicast traffic to the remote end, a traffic policy matches on multicast traffic to remove the Ethernet header from multicast packets before forwarding the packet using the specified MPLS-over-GRE encapsulation. During decapsulation upon receiving multicast traffic from the remote end, the static MPLS label serves to identify an egress port on which to forward the received packets and a multicast destination Media Access Control (DMAC) address is computed.

### BACKGROUND

Tunneling is often used to support VPN (Virtual Private Network) based services, where customer traffic is forwarded between two geographically distributed locations over a tunnel. A point-to-point VPN service is one where all traffic received on a given local physical/logical interface is forwarded to a specific remote tunnel endpoint. Pseudowires are commonly used to support point-to-point VPN services. A pseudowire is a networking technique where a circuit is emulated in an existing network. A pseudowire can be viewed as a virtual wire on an existing packet-switched network.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 shows an example high-level representation of a communication system in accordance with the present disclosure.

FIG. 2 represents an example of packet processing in accordance with the present disclosure.

FIG. 3 is an example high-level flow of operations for downstream processing of packets in accordance with the present disclosure.

FIG. 4 is an illustrative example of a traffic policy used in downstream processing of packets in accordance with the present disclosure.

FIG. 5 illustrates an example of processing of a packet during downstream processing of packets in accordance with the present disclosure.

FIGS. 6A, 6B illustrate encapsulation examples in accordance with the present disclosure.

FIG. 7 is an example of high-level flow of operations for upstream processing of packets in accordance with the present disclosure.

FIG. 8 illustrates an example of processing of a packet during upstream processing of packets in accordance with the present disclosure.

FIG. 9 represents details of an example network device.

### DETAILED DESCRIPTION

The present disclosure supports multicast traffic in a point-to-point connection based on pseudowire technology, where all traffic received on a given local physical/logical interface is forwarded to a specific remote tunnel endpoint. Aspects of the present disclosure include:
In a forward (downstream, encapsulation) direction, the multicast IP (Internet Protocol) packets received on a specified local interface are forwarded over a tunnel to a remote endpoint. In some embodiments, a traffic policy is used to match on multicast traffic and determine whether or not to strip the Ethernet header from a multicast packet before forwarding the packet downstream to the remote end.
In a reverse (upstream, decapsulation) direction, a static MPLS label in a received multicast packet is used to identify an egress port and to trigger reconstruction of an Ethernet header (based on the inner payload multicast IP address) if the received multicast packet does not contain the inner Ethernet header.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

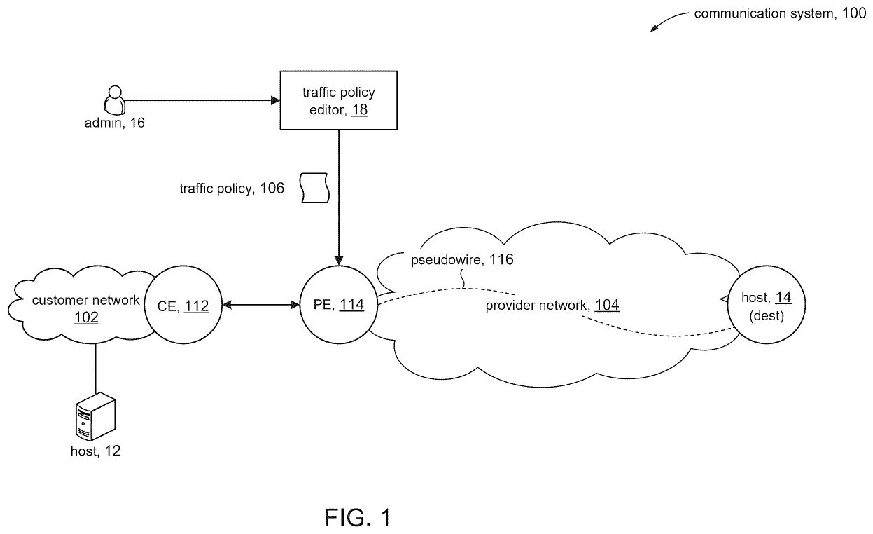

FIG. 1 shows a simplified communication system to illustrate aspects of the present disclosure. In some embodiments, communication system 100 can include a customer network 102 and a provider network 104. Customer network 102 can include a CE (customer edge network device) 112. Provider network 104 can include a PE (provider edge network device) 114. Communication between customer network 102 and provider network 104 occurs between respective edge devices 112 and 114, allowing host machines (e.g., host 12) on the customer network to access services on the provider network (e.g., host 14 can be a server).

Provider network 104 can be configured to provide tunneling between PE 114 and host 14 using pseudowire technology to provide point-to-point VPN (Virtual Private Network) based services. Provider network 104 can implement a VPN tunnel over a variety of transport mechanisms such as MPLS (Multipath Label Switching), IPv4/v6 routing, GRE (Generic Routing Encapsulation), GUE (Generic User Datagram Protocol Encapsulation), VxLAN (Virtual Extensible Local Area Network), etc.

Provider network 104 can be configured with pseudowires to support point-to-point VPN services. In some embodiments, PE 114 can be viewed as being connected to host 14 via a pseudowire 116, providing a virtual or emulated point-to-point connection between the PE and host. Pseudowires can carry suitable Layer 2 packets such as Ethernet, ATM (asynchronous transfer mode), frame relay, and the like. Pseudowire 116 can be based on any suitable routing technique, such as for example, IPv4 (Version 4 Internet Protocol), IPv6 (Version 6 Internet Protocol), and other Layer 3 routing technologies. Pseudowires are typically only used to forward L2 (Layer 2) traffic as-is without any modification to the L2 packets. However, in the case of multicast traffic, some deployments require stripping the Ethernet header from multicast frames before sending them over a tunnel and then constructing a multicast compatible Ethernet header at the destination.

User 16 provides traffic policy 106 (e.g., via traffic policy editor 18) to PE 114. The traffic policy 106 which can be programmed into forwarding tables (not shown) in PE 114 process and forward multicast packets in accordance with the present disclosure.

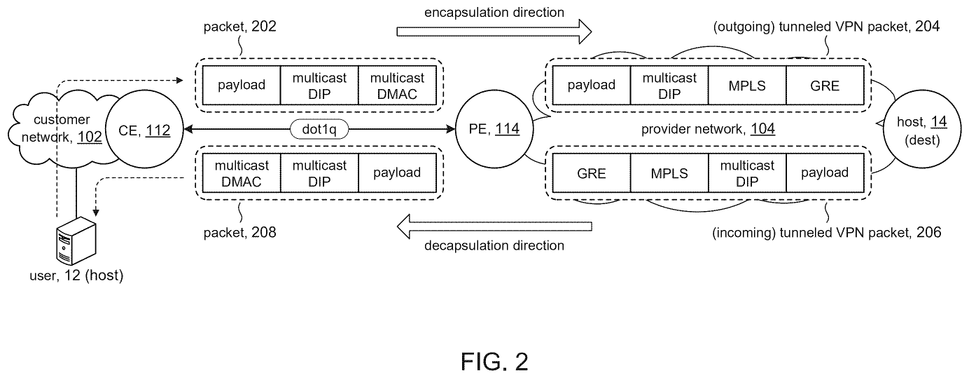

FIG. 2 illustrates an example of processing a multicast packet in accordance with the present disclosure. Host 12 may broadcast a multicast packet 202 into customer network 102. CE 112 can receive and transmit packet 202 to PE 114. In some embodiments, for example, CE 112 can transmit packet 202 to PE 114 over an 802.1q VLAN (Virtual Local Area Network).

In the downstream (encapsulation) direction, PE 114 can process (incoming) packet 202 to generate an outgoing tunneled VPN packet 204. In accordance with the present disclosure, traffic policy 106 can be used to match on the DIP (destination IP) multicast address contained in incoming packet 202 received on a specified port of the PE. Depending on the traffic policy the Ethernet header may or may not be stripped. Packet 202 can be encapsulated as outgoing packet 204. Outgoing packet 204 comprises incoming packet 202 (with or without its Ethernet header) along with a static MPLS (Multipath Label Switching) label. Outgoing packet 204 can then be transmitted over pseudowire 116 (FIG. 1) to the remote endpoint, namely host 14. Host 14 can remove the tunnel (i.e., decapsulate tunneled packet 204) to recover packet 202 and process the recovered packet.

In the upstream (decapsulation) direction, host 14 can send a tunneled VPN packet 206 that encapsulates a multicast packet over pseudowire 116 to PE 114. PE 114 can process the (incoming) tunneled packet 206 to generate (outgoing) packet 208, including removing the tunnel header, constructing a multicast Ethernet header, and using a static MPLS label contained in the tunneled packet 206 to identify an egress interface on PE 114. Outgoing packet 208 can then be transmitted over the identified egress interface.

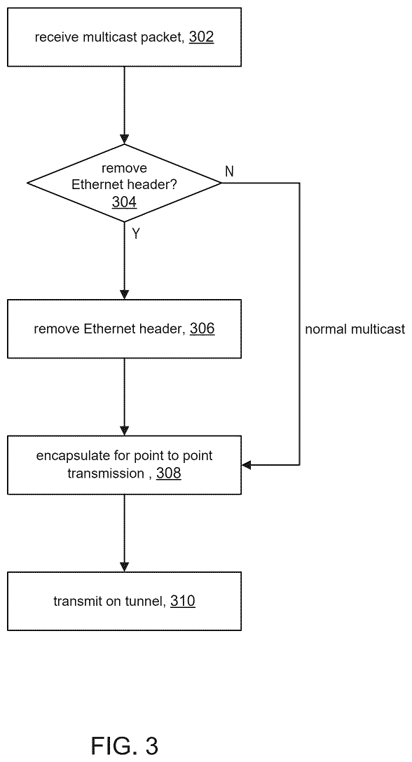

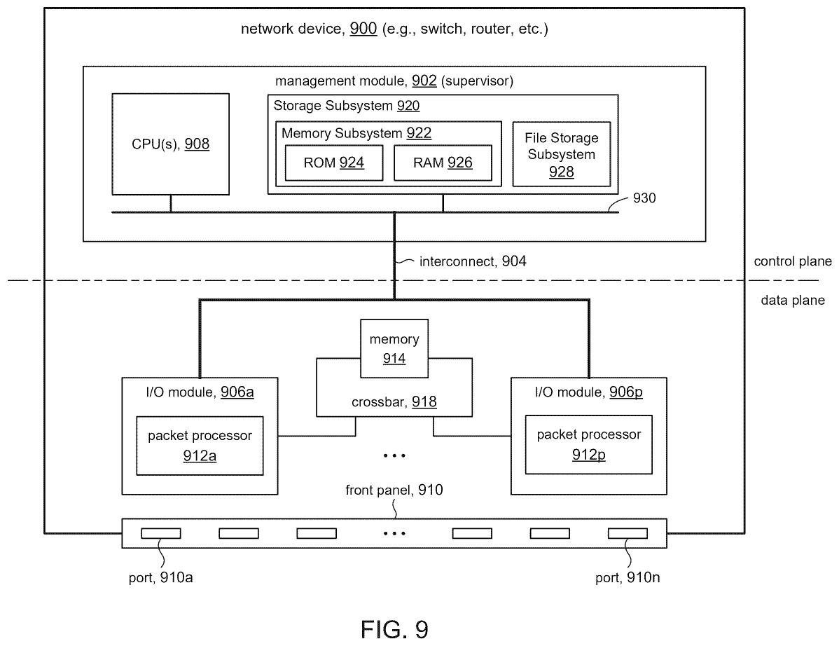

Referring to FIGS. 3-5, 6A, and 6B, the discussion will now turn to a high-level description of operations in an edge device (e.g., PE 114, FIG. 1) on a provider network (e.g., 104) to transmit multicast packets to hosts (e.g., 14) connected to the provider network. In some embodiments, for example, the PE can include computer executable program code (e.g., stored on a non-transitory computer-readable storage memory device), which when executed by a processor (e.g., 908, FIG. 9), can cause the computer system to perform processing in accordance with FIG. 3. The operations described below are not necessarily executed in the order shown. Operations can be combined or broken out into smaller operations in various embodiments. Operations can be allocated for execution among one or more concurrently executing processes and/or threads.

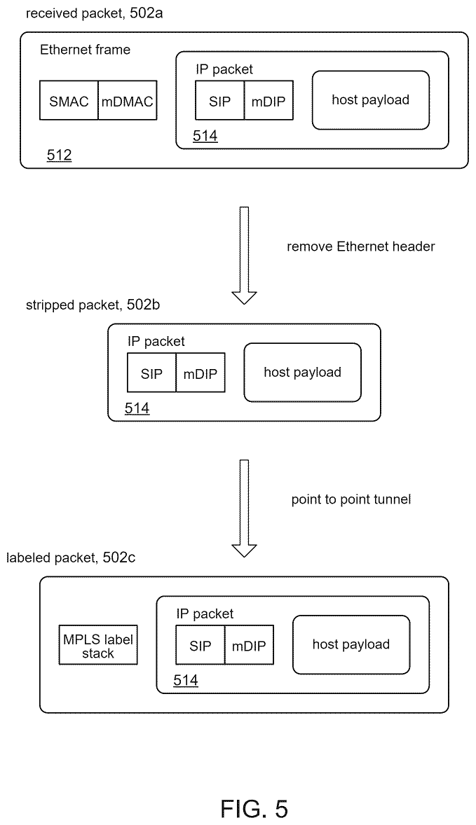

At operation 302, the PE can receive a multicast packet. The packet can include a multicast DIP. For IPv4 packets, a multicast address is an address that falls in the range:
224.0.0.0 to 239.255.255.255.
   For IPv6 packets, a multicast address falls in the range ff00::/8; in other words, all IPv6 multicast addresses start with “0xff”. FIG. 2, for example, shows CE 114 sends a multicast packet 202 (e.g., from host 12) to PE 114. Referring for a moment to the sequence in FIG. 5, packet 502a represents an example of a received multicast packet.

At decision point 304, if the Ethernet header in the received multicast packet should be removed, then processing can continue to operation 306; otherwise, processing can proceed to operation 308 with the Ethernet header intact. Some use cases, for example, may require removing the Ethernet header from all multicast packets. In accordance with the present disclosure, when a multicast packet is matched on by specifying a “multicast” packet type, the Ethernet header will be removed from the packet; otherwise, if the multicast packet is matched on using a destination prefix, then the Ethernet header remains intact.

In some embodiments, the PE can determine that a multicast packet is a multicast-type packet using a traffic policy that can be programmed in the PE. In some embodiments, for example, the traffic policy can support a “multicast” packet type attribute that the user (e.g., a network administrator) can use to create a traffic policy in order to remove Ethernet headers from all multicast packets; e.g., the user can specify a rule using the “multicast” packet type attribute.

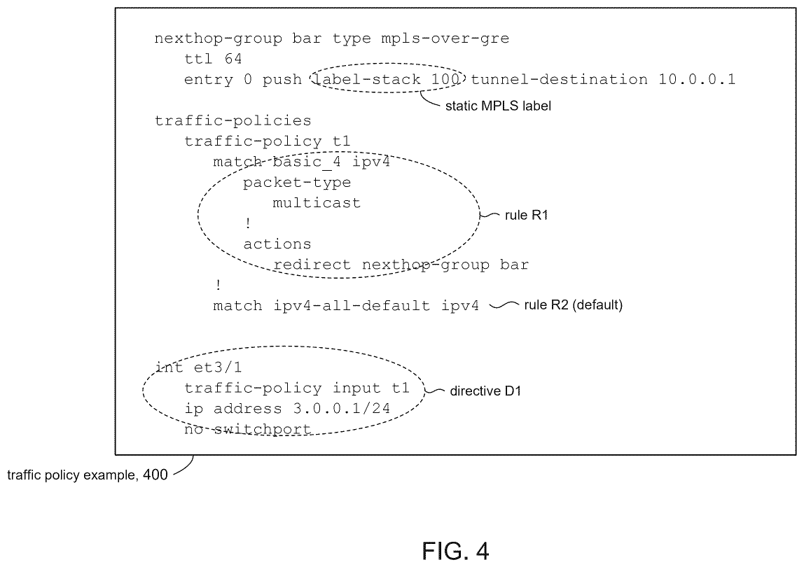

Referring for a moment to FIG. 4, an example traffic policy 400 comprises a rule that designates multicast packets as “multicast-type” multicast packets. Traffic policy 400 includes a forwarding rule R1 called “basic_4.” The rule specifies the “multicast” packet type attribute which will match on any IPv4 packet whose DIP address is in the range of multicast addresses. In the example, the rule is triggered by a directive D1 for logical interface et3/1 of the PE, where packets that ingress on logical interface et3/1 invoke traffic policy “t1”, and traffic policy t1 in turn invokes rule R1 to match for multicast-type packets. The corresponding action in rule R1 redirects the packet over a tunneled VPN connection called “bar.” In some embodiments, the VPN connection can be identified using a static MPLS label. The example traffic policy 400, for instance, includes a tunnel definition that specifies a static MPLS label ‘100’ to identify the VPN connection. Although not shown in the example traffic policy, it will be appreciated that in other embodiments, the static MPLS label can be inserted by way of a traffic policy action.

At operation 306, the PE can remove the Ethernet header. Referring for a moment to the sequence in FIG. 5, packet 502a represents the multicast packet received at operation 302 that is then recognized by the traffic policy at decision point 304 as a multicast-type packet. Packet 502a comprises an Ethernet frame 512. The header component of Ethernet frame 512 comprises a SMAC (source Media Access Control) address and a multicast DMAC address. The payload component of Ethernet frame 512 is IP packet 514 from the sending host. IP packet 514 in turn comprises a SIP address and a multicast DIP address (IP header) and the host payload. Removing the Ethernet header results in the stripped packet 502b shown in FIG. 5 comprising IP packet 514.

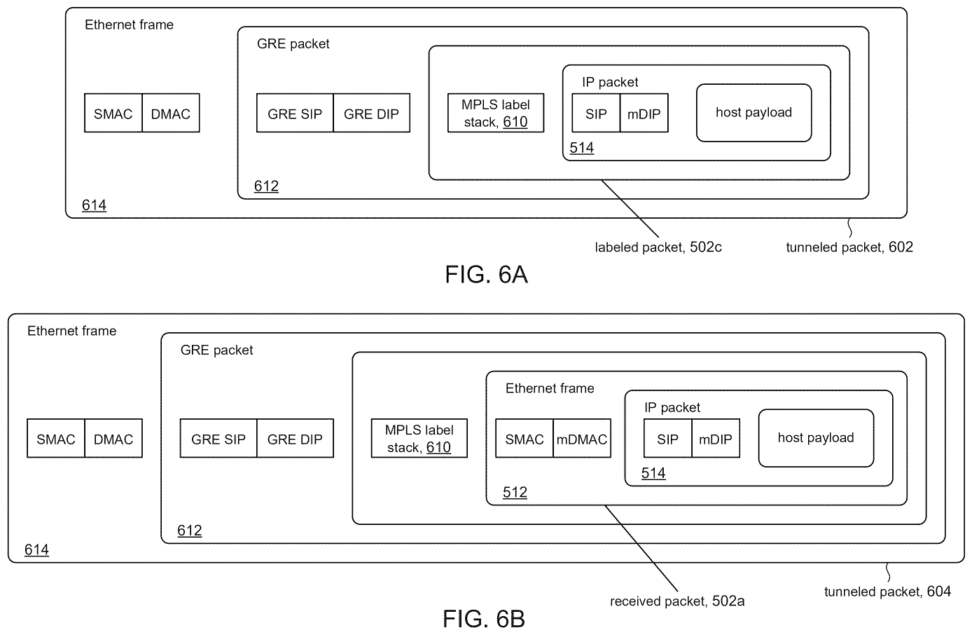

At operation 308, the PE can encapsulate multicast packet 502a (‘N’ branch of decision point 304 where the Ethernet header is retained) or IP packet 514 (‘Y’ branch of decision point 304 where stripping the Ethernet header is required) for point-to-point tunneling (pseudowire) to the identified VPN. In accordance with the present disclosure, MPLS label stack 610 is added to the packet and a static MPLS label pushed onto the MPLS label stack. The static MPLS label serves to identify the VPN. In some embodiments, the static MPLS label can be obtained from the traffic policy. For example, traffic policy 400 in FIG. 4 shows a static MPLS label ‘100’. For discussion purposes, GRE (Generic Routing Encapsulation) tunneling will be used as an example, but it will be appreciated that any tunneling protocol can be used:
stripping the Ethernet header is required—In the case where stripping the Ethernet header is required, MPLS label stack 610 can be added to IP packet 514 to produce labeled packet 502c as shown in FIG. 5. Labeled packet 502c can be encapsulated in a GRE packet. Referring to FIG. 6A, labeled packet 502c is shown encapsulated in a GRE packet 612, which in turn is encapsulated in Ethernet frame 614 for transmission as tunneled packet 602.
Ethernet header is retained—In the case where the Ethernet header is retained, MPLS label stack 610 is added to the received multicast packet 502a itself, and the pair can be encapsulated in a GRE packet. Referring to FIG. 6B, the originally received packet 502a is shown encapsulated in a GRE packet 612, which in turn is encapsulated in Ethernet frame 614 for transmission as tunneled packet 604.

At operation 310, the PE can transmit the tunneled packet to the destination; e.g., host 14 (FIG. 2). The host can extract the static MPLS label to identify the VPN and process the packet accordingly, the details of which are not relevant to the present disclosure.

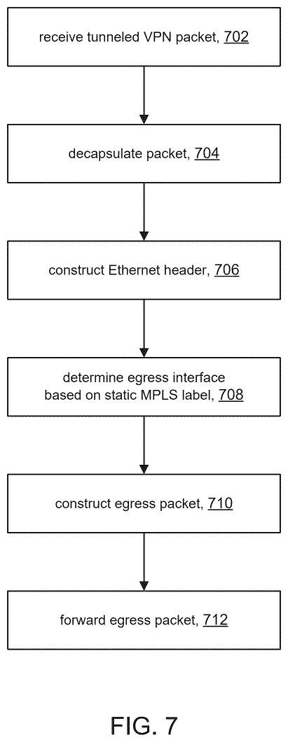

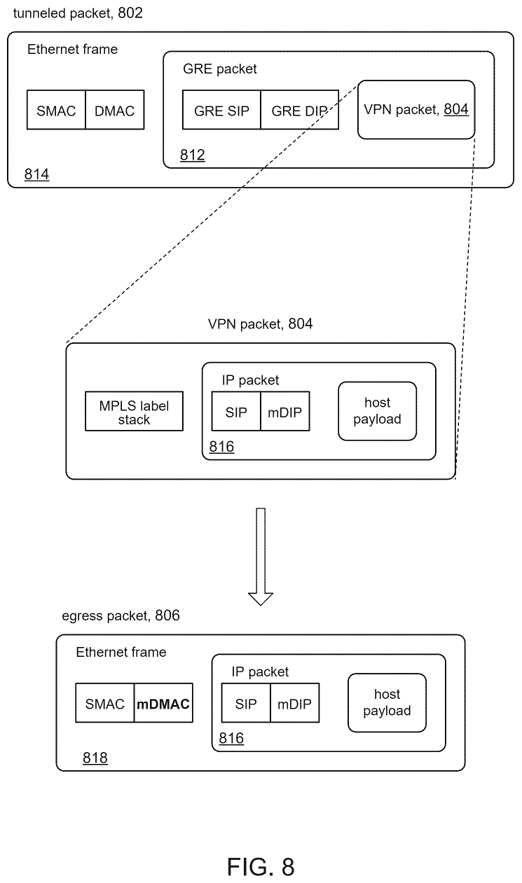

Referring to FIGS. 7 and 8, the discussion will now turn to a high level description of operations in an edge device (e.g., PE 114, FIG. 1) on a provider network (e.g., 104), to process tunneled packets from a host (e.g., 14) connected to the provider network in accordance with the present disclosure. In some embodiments, for example, the PE can include computer executable program code (e.g., stored on a non-transitory computer-readable storage memory device), which when executed by a processor (e.g., 908, FIG. 9), can cause the computer system to perform processing in accordance with FIG. 7. The operations described below are not necessarily executed in the order shown. Operations can be combined or broken out into smaller operations in various embodiments. Operations can be allocated for execution among one or more concurrently executing processes and/or threads.

At operation 702, the PE receives a tunneled VPN packet from a host on the provider network. FIG. 2, for example, shows host 14 sending tunneled VPN packet 206 to PE 114.

At operation 704, the PE can remove the Ethernet and GRE headers by decapsulating the received tunneled packet to recover the VPN packet. Referring for a moment to the example in FIG. 8, for instance, the PE can receive tunneled packet 802 from a host. The tunneled packet 802 comprises an Ethernet frame 814 whose payload component is GRE packet 812, and the GRE packet in turn encapsulates VPN packet 804 sent by the host.

Decapsulating GRE packet 812 (i.e., removing the GRE header) recovers VPN packet 804 comprising an MPLS label stack and a payload component IP packet 816. The MPLS label stack contains a static MPLS label which, as explained above, identifies the VPN that the packet came from. IP packet 816 comprises SIP address (IP address of the sending host), a multicast DIP address, and the host payload.

At operation 706, the PE can construct an Ethernet header for Ethernet frame 818. The SMAC address is the MAC address of the PE. A multicast DMAC address for the Ethernet header can be computed based on the multicast DIP address contained in IP packet 816. Computing the multicast DMAC address for a multicast packet is a known, standardized operation that uses a portion of the multicast DIP address.

At operation 708, the PE can pop the MPLS label stack to obtain the static MPLS label. In accordance with the present disclosure, the PE can map the static MPLS label to an egress port on the PE using, for example, a lookup table that associates MPLS labels to the PE's egress ports.

At operation 710, the PE can construct an egress packet. Referring to FIG. 8, for example, the multicast DMAC address computed at operation 706 can be incorporated into the header component of Ethernet frame 818, and the MPLS label stack can be removed from the VPN packet 804, leaving IP packet 816. The payload of Ethernet frame 818 comprises the IP packet 816. Ethernet frame 818 constitutes egress packet 806.

At operation 712, the PE can transmit the constructed egress packet. In accordance with the present disclosure, the egress port identified at operation 708 is used to transmit the egress packet (e.g., egress packet 806).

FIG. 9 is a schematic representation of a network device 900 (e.g., a router, switch, firewall, and the like) that can be adapted in accordance with the present disclosure. In some embodiments, for example, network device 900 can include one or more management modules 902, one or more I/O modules (switches, switch chips) 906a-906p, and a front panel 910 of I/O ports (physical interfaces, I/Fs) 910a-910n. Management module 902 can constitute the control plane of network device 900 (also referred to as the control layer or simply the central processing unit, CPU), and can include CPU(s) 908 for managing and controlling operation of network device 900 in accordance with the present disclosure. CPU(s) 908 can be a general-purpose processor, such as an Intel®/AMD® x86, ARM® microprocessor and the like, that operates under the control of software stored in a memory device/chips such as read-only memory (ROM) 924 or random-access memory (RAM) 926. The control plane provides services that include traffic management functions such as routing, security, load balancing, analysis, and the like.

CPU(s) 908 can communicate with storage subsystem 920 via bus subsystem 930. Other subsystems, such as a network interface subsystem (not shown in FIG. 9), may be on bus subsystem 930. Storage subsystem 920 can include memory subsystem 922 and file/disk storage subsystem 928. Memory subsystem 922 and file/disk storage subsystem 928 represent examples of non-transitory computer-readable storage devices that can store program code and/or data, which when executed by CPU(s) 908, can cause CPU(s) 908 to perform operations in accordance with embodiments of the present disclosure.

Memory subsystem 922 can include a number of memories such as main RAM 926 (e.g., static RAM, dynamic RAM, etc.) for storage of instructions and data during program execution, and ROM (read-only memory) 924 on which fixed instructions and data can be stored. File storage subsystem 928 can provide persistent (i.e., non-volatile) storage for program and data files, and can include storage technologies such as solid-state drive and/or other types of storage media known in the art.

CPU(s) 908 can run a network operating system stored in storage subsystem 920. A network operating system is a specialized operating system for network device 900. For example, the network operating system can be the Arista EOS® operating system, which is a fully programmable and highly modular, Linux-based network operating system developed and sold/licensed by Arista Networks, Inc. of Santa Clara, California. It is understood that other network operating systems may be used.

Bus subsystem 930 can provide a mechanism for the various components and subsystems of management module 902 to communicate with each other as intended. Although bus subsystem 930 is shown schematically as a single bus, alternative embodiments of the bus subsystem can utilize multiple buses.

The one or more I/O modules 906a-906p can be collectively referred to as the data plane of network device 900 (also referred to as the data layer, forwarding plane, etc.). Interconnect 904 represents interconnections between modules in the control plane and modules in the data plane. Interconnect 904 can be any suitable bus architecture such as Peripheral Component Interconnect Express (PCIe), System Management Bus (SMBus), Inter-Integrated Circuit (I²C), etc.

I/O modules 906a-906p can include respective packet processing hardware comprising packet processors 912a-912p (collectively 912) to provide packet processing and forwarding capability. Each I/O module 906a-906p can be further configured to communicate over one or more ports 910a-910n on the front panel 910 to receive and forward network traffic. Packet processors 912 can comprise hardware (circuitry), including for example, data processing hardware such as an application specific integrated circuit (ASIC), field programmable gate array (FPGA), processing unit, and the like, which can be configured to operate in accordance with the present disclosure. Packet processors 912 can include forwarding lookup hardware such as, for example, but not limited to content addressable memory such as ternary CAMs (TCAMs) and auxiliary memory such as static RAM (SRAM).

Memory hardware 914 can include buffers used for queueing packets. I/O modules 906a-906p can access memory hardware 914 via crossbar 918. It is noted that in other embodiments, the memory hardware 914 can be incorporated into each I/O module. The forwarding hardware in conjunction with the lookup hardware can provide wire speed decisions on how to process ingress packets and outgoing packets for egress. In accordance with some embodiments, some aspects of the present disclosure can be performed wholly within the data plane.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A method in a network device, the method comprising:
receiving a traffic policy comprising a first forwarding rule that matches on all packets that have a destination IP (Internet Protocol) address that is a multicast address;
programming the traffic policy in one or more forwarding tables in the network device;
receiving a first packet on a first interface of the network device, the first packet having a multicast destination IP address;
matching the first packet to the first forwarding rule in the traffic policy;
in response to matching the first forwarding rule:
removing an Ethernet header from the first packet, leaving a multicast IP packet; and
producing a second packet for egress in accordance with a tunneling protocol by encapsulating (1) the multicast IP packet and (2) a VPN (virtual private network) identifier; and
transmitting the second packet to a remote device.

2. The method of claim 1, wherein the traffic policy is defined by a user.

3. The method of claim 1, further comprising adding an MPLS (Multipath Label Switching) label stack with the multicast IP packet and pushing an MPLS label on the MPLS label stack that represents the VPN.

4. The method of claim 3, wherein the MPLS label is based on a logical interface on the network device on which the first packet is received.

5. The method of claim 3, wherein the MPLS label is specified in the traffic policy.

6. The method of claim 1, further comprising:
receiving a tunneled packet from the remote device, the tunneled packet comprising a third packet, the third packet including a second multicast IP packet and an MPLS label stack;
decapsulating the tunneled packet to recover the second multicast IP packet and the MPLS label stack;
constructing an egress packet including generating an Ethernet header for the egress packet using a multicast destination IP address in the second multicast IP packet; and
transmitting the egress packet on an interface of the network device determined based on an MPLS label on the MPLS label stack.

7. The method of claim 6, wherein generating the Ethernet header includes computing a destination MAC address using the multicast destination IP address in the second multicast IP packet.

8. A network device comprising:
one or more computer processors; and
a computer-readable storage device comprising instructions for controlling the one or more computer processors to:
receive a traffic policy comprising a first forwarding rule that matches on all packets that have a destination IP address that is a multicast address;
program the traffic policy in one or more forwarding tables in the network device;
receive a first packet on a first interface of the network device, the first packet having a multicast destination IP address;
match the first packet to the first forwarding rule in the traffic policy;
in response to matching the first forwarding rule:
remove an Ethernet header from the first packet, leaving a multicast IP packet; and
produce a second packet for egress in accordance with a tunneling protocol by encapsulating (1) the multicast IP packet and (2) a VPN identifier; and
transmit the second packet to a remote device.

9. The network device of claim 8, wherein the traffic policy is defined by a user.

10. The network device of claim 8, wherein the computer-readable storage device further comprises instructions for controlling the one or more computer processors to include an MPLS label stack with the multicast IP packet and push an MPLS label on the MPLS label stack that represents the VPN.

11. The network device of claim 10, wherein the MPLS label is based on a logical interface on the network device on which the first packet is received.

12. The network device of claim 10, wherein the MPLS label is specified in the traffic policy.

13. The network device of claim 8, wherein the computer-readable storage device further comprises instructions for controlling the one or more computer processors to:
receive a tunneled packet from the remote device, the tunneled packet comprising a third packet, the third packet including a second multicast IP packet and an MPLS label stack;
decapsulate the tunneled packet to recover the second multicast IP packet and the MPLS label stack;
construct an egress packet including generating an Ethernet header for the egress packet using a multicast destination IP address in the second multicast IP packet; and
transmit the egress packet on an interface of the network device determined based on an MPLS label on the MPLS label stack.

14. The network device of claim 13, wherein generating the Ethernet header includes computing a destination MAC address using the multicast destination IP address in the second multicast IP packet.

15. A non-transitory computer-readable storage device in a network device, the non-transitory computer-readable storage device having stored thereon computer executable instructions, which when executed, cause the network device to:
receive a traffic policy comprising a first forwarding rule that matches on all packets that have a destination IP address that is a multicast address;
program the traffic policy in one or more forwarding tables in the network device;
receive a first packet on a first interface of the network device, the first packet having a multicast destination IP address;
match the first packet to the first forwarding rule in the traffic policy;
in response to matching the first forwarding rule:
remove an Ethernet header from the first packet, leaving a multicast IP packet; and
produce a second packet for egress in accordance with a tunneling protocol by encapsulating (1) the multicast IP packet and (2) a VPN identifier; and
transmit the second packet to a remote device.

16. The non-transitory computer-readable storage device of claim 15, wherein the traffic policy is defined by a user.

17. The non-transitory computer-readable storage device of claim 15, wherein the computer executable instructions, which when executed, further cause the network device to include an MPLS label stack to the multicast IP packet and push an MPLS label on the MPLS label stack that represents the VPN.

18. The non-transitory computer-readable storage device of claim 17, wherein the MPLS label is specified in the traffic policy.

19. The non-transitory computer-readable storage device of claim 15, wherein the computer executable instructions, which when executed, further cause the network device to:
receive a tunneled packet from the remote device, the tunneled packet comprising a third packet, the third packet including a second multicast IP packet and an MPLS label stack;
decapsulate the tunneled packet to recover the second multicast IP packet and the MPLS label stack;
construct an egress packet including generating a multicast compatible Ethernet header for the egress packet using a multicast destination IP address in the second multicast IP packet; and
transmit the egress packet on an interface of the network device determined based on an MPLS label on the MPLS label stack.

20. The non-transitory computer-readable storage device of claim 19, wherein generating the Ethernet header includes computing a destination MAC address using the multicast destination IP address in the second multicast IP packet.
